(19) United States
(12) Patent Application Publication
(10) Pub. No.: US 2011/0208644 A1
(43) Pub. Date: Aug. 25, 2011

(54) MONEY MANAGEMENT SYSTEM

(76) Inventors: Kazuhiro Doi, Hyogo-Ken (JP); Shinji Oba, Hyogo-Ken (JP); Tasuku Nakamoto, Hyogo-Ken (JP)

(21) Appl. No.: 12/737,837

(22) PCT Filed: Aug. 21, 2008
(86) PCT No.: PCT/JP2008/064919

§ 371 Date: Apr. 28, 2011

(51) Int. Cl. G06Q 40/00

(52) U.S. Cl. 705/39

(57) ABSTRACT

A money management system includes a money handling machine 10 located in a store and owned by an armored car company, and an armored car services management server 25 located in the armored car company, the armored car services management server 25 being configured to obtain storage information about money stored in the money handling machine 10 and to store the storage information. A deposit accepting process is performed based on collection completed information indicating that money has been collected from the money handling machine 10.

### FIELD OF THE INVENTION

The present invention relates to a money management system that performs a deposit accepting process.

### BACKGROUND ART

There has been conventionally known a money management system including: a store-side apparatus having a deposit machine (money handling machine) to which sales proceeds of a store are deposited, and communication means; and a center apparatus of an armored car company connected to the store-side apparatuses of respective stores through communication lines (JP9-16691A). In JP9-16691A, the deposit machine located in the store includes; a money handling unit that recognizes and counts money, when money of sales proceeds of the store is put into the money handling unit for deposit; a data processing unit that stores the counted sum, and transmits deposit data (including a deposit sum and an identifier of the store) to the center apparatus through the communication means; and a safe unit that stores the recognized and counted money. Upon receipt of the deposit data transmitted from the deposit machine, the center apparatus of the safety transport company can perform a process for depositing the deposit sum to a bank account corresponding to the identifier of the store, and can collect the money in the safe unit of the deposit machine of the store.

Although the armored car company performs a deposit process to a financial institution, such as a bank, and collects the money in the safe unit of the deposit machine of the store, the deposit machine (money handling machine) 70, to which sales proceeds of the store are deposited, is owned by the client. Thus, it is often the case that the deposit machine 70 is not sufficiently maintained (see, FIG. 8).

Thus, even when the money is counted by the deposit machine (money handling machine) 70 of the client and the deposit data are transmitted to the center apparatus of the armored car company, a deposit accepting process (see, FIG. 8) is performed after the collected money has been taken to the center apparatus of the armored car company by transport means 35, delivery of money has been confirmed by a stocking machine 20, and then the money has been counted by a money handling machine 75 owned and maintained by -the armored car company. Thus, it takes a long time from a time when the money is collected from the deposit machine (money handling machine) 70 located in the store, to when the deposit accepting process is performed. After the deposit accepting process of the money has been performed, the money is sorted by denomination, sorted by fitness, and/or bundled, by a money processing unit 71.

In general, money is counted by the deposit machine (money handling machine) 70 located in the store. However, as described above, since it is often the case that the deposit machine (money handling machine) 70 is not sufficiently maintained, it is necessary to again count the money by the money handling machine 75 owned by the armored car company. When the count result of the deposit machine (money handling machine) 70 located in the store does not correspond to the count result of the money handling machine 75 owned by the armored car company, it is necessary to amend the count result of the deposit machine (money handling machine) 70 located in the store.

### DISCLOSURE OF THE INVENTION

The present invention has been made in view of the above circumstances. The object of the present invention is to provide a money management system that is capable of performing a deposit accepting process at an early stage, and thus is capable of using money whose deposit sum has been accepted in various applications at an early stage.

A money management system in a first aspect according to the present invention is a money management system comprising: a money handling machine located in a store and owned by an armored car company; and an armored car services management server located in the armored car company, the armored car services management server being configured to obtain storage information about money stored in the money handling machine and to store the storage information; wherein a deposit accepting process is performed based on collection completed information indicating that money has been collected from the money handling machine.

In the money management system in the first aspect according to the present invention, it is preferable that the collection completed information includes a collection notice that is sent from the money handling machine to the armored car services management server to inform that the money has been collected from the money handling machine, and that the deposit accepting process is performed when the armored car services management server receives the collection notice.

It is preferable that the money management system in the first aspect according to the present invention further comprises a money receiving unit located in the armored car company, the money receiving unit being configured to confirm delivery of money by using collection information about money that has been collected from the money handling machine, wherein the collection completed information includes the collection information, and the deposit accepting process is performed when it has been confirmed that the collection information and the storage information conform to each other.

In the money management system in the first aspect according to the present invention, it is preferable that the money handling machine is configured to transmit the storage information to the armored car services management server each time the money handling machine processes money.

In the money management system in the first aspect according to the present invention, it is preferable that the money handling machine is configured to sum up processed money so as to create the storage information, and to transmit the storage information to the armored car services management server.

In the money management system in the first aspect according to the present invention, it is preferable that the money handling machine is configured to transmit, as the storage information, information about the store in which the money handling machine is located, or information about the money handling machine itself, and information about money stored in the money handling machine, to the armored car services management server.

In the money management system in the first aspect according to the present invention, it is preferable that when money is collected from the money handling machine, the money handling machine is configured to print on a paper medium the collection information about the money collected from the money handling machine, or to store in a memory medium the collection information about the money collected from the money handling machine.

It is preferable that the money management system in the first aspect according to the present invention further comprises a portable terminal, wherein the armored car services management server is configured to transmit to the portable terminal a sum of money to be taken to the armored car company and a sum of money to be used for a replenishing process.

In the money management system in such an aspect, it is preferable that the armored car services management server is configured to obtain balance information about a balance (amount of money) in a money handling machine to be replenished, and to determine the sum of money to be taken to the armored car company and the sum of money to be used for a replenishing process, based on the balance information and the storage information.

A money management system in a second aspect according to the present invention is a money management system comprising: a money handling machine located in a store and owned by a financial institution; and an armored car services management server located in an armored car company, the armored car services management server being configured to obtain storage information about money stored in the money handling machine and to store the storage information therein; wherein a deposit accepting process is performed based on collection completed information indicating that money has been collected from the money handling machine.

In the money management system in the second aspect according to the present invention, it is preferable that the collection completed information includes a collection notice that is sent from the money handling machine to the armored car services management server to inform that the money has been collected from the money handling machine, and that the deposit accepting process is performed when the armored car services management server receives the collection notice.

It is preferable that the money management system in the second aspect according to the present invention further comprises a money receiving unit located in the armored car company, the money receiving unit being configured to confirm delivery of money by using collection information about money that has been collected from the money handling machine, wherein the collection completed information includes the collection information, and the deposit accepting process is performed when it has been confirmed that the collection information and the storage information conform to each other.

It is preferable that the money management system in the second aspect according to the present invention further comprises a financial management server located in the financial institution, the financial management server being configured to obtain the storage information about money stored in the money handling machine, and to store the storage information therein.

In the money management system in the second aspect according to the present invention, it is preferable that the money handling machine is configured to transmit the storage information to the armored car services management server each time the money handling machine processes money.

In the money management system in the second aspect according to the present invention, it is preferable that the money handling machine is configured to sum up processed money so as to create the storage information, and to transmit the storage information to the armored car services management server.

In the money management system in the second aspect according to the present invention, it is preferable that the money handling machine is configured to transmit, as the storage information, information about the store in which the money handling machine is located, or information about the money handling machine itself, and information about money stored in the money handling machine, to the armored car services management server.

In the money management system in the second aspect according to the present invention, it is preferable that when money is collected from the money handling machine, the money handling machine is configured to print on a paper medium the collection information about the money collected from the money handling machine, or to store in a memory medium the collection information about the money collected from the money handling machine.

It is preferable that the money management system in the second aspect according to the present invention further comprises a portable terminal, wherein the armored car services management server is configured to transmit to the portable terminal a sum of money to be taken to the armored car company and a sum of money to be used for a replenishing process.

In the money management system in such an aspect, it is preferable that the armored car services management server is configured to obtain balance information about a balance (amount of money) in a money handling machine to be replenished, and to determine the sum of money to be taken to the armored car company and the sum of money to be used for a replenishing process, based on the balance information and the storage information.

A money management system in a third embodiment according to the present invention is a money management system comprising: a money handling machine located in a store and owned by a financial institution; and an armored car services management server located in the financial institution, the armored car services management server being configured to obtain storage information about money stored in the money handling machine and to store the storage information; wherein a deposit accepting process is performed based on collection completed information indicating that money has been collected from the money handling machine.

### BRIEF DESCRIPTION OF THE DRAWINGS

FIG. 1 is a schematic view showing a structure of a money management system in a first embodiment according to the present invention.

FIG. 2 is a schematic view showing a structure of a money management system in a second embodiment according to the present invention.

FIG. 3 is a schematic view showing a structure of a money management system in a third embodiment according to the present invention.

FIG. 4 is a schematic view showing a structure of a money management system in a fourth embodiment according to the present invention.

FIG. 5 is a schematic view showing a structure of a money management system in a fifth embodiment according to the present invention.

FIG. 6 is a schematic view showing a structure of a money management system in a sixth embodiment according to the present invention.

FIG. 7 is a schematic view showing a structure of a money management system in a seventh embodiment according to the present invention.

FIG. 8 is a schematic view showing a structure of a conventional money management system.

### MODES FOR CARRYING OUT THE INVENTION

### First Embodiment

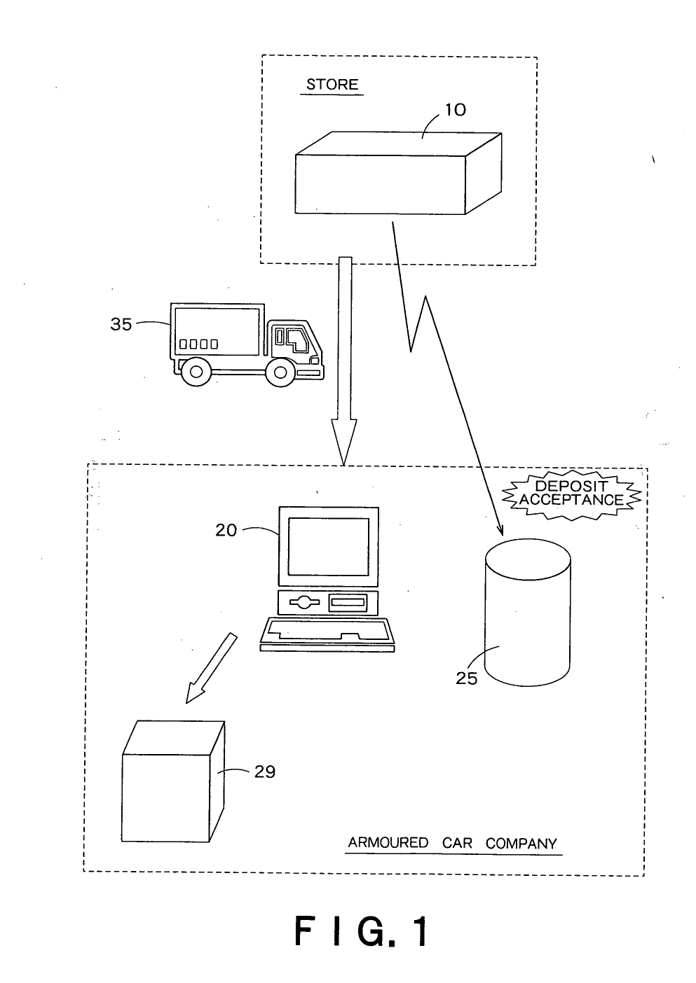

A first embodiment of a money management system according to the present invention will be described below with reference to the drawings. FIG. 1 is a view showing the first embodiment of the present invention.

As shown in FIG. 1, the money management system includes: a money handling machine 10 located in a store and owned by an armored car company; an armored car services management server 25 located in a center of the armored car company, the armored car services management server 25 being configured to obtain storage information about money stored in the money handling machine 10 located in the store from the money handling machine 10 and to store the storage information; and a money receiving unit 20 located in the armored car company, the money receiving unit 20 being configured to confirm delivery of money by using collection information about money that has been collected from the money handling machine 10. In this embodiment, when the armored car services management server 25 receives collection notice (collection completed information) indicating that money has been collected from the money handling machine 10, the deposit accepting process is performed.

The money handling machine 10 located in the store is configured to transmit to the armored car services management server 25, as the storage information, information about the store in which the money handling machine 10 is located (location information of the store, number of the store, etc.), information about the money handling machine 10 itself (number of the money handling machine 10 etc.), and information about a sum of the money stored in the money handling machine 10 (the number of banknotes for each denomination). Each time the money handling machine 10 processes money, the money handling machine 10 is configured to transmit to the armored car services management server 25 information about the store in which the money handling machine 10 is located, information about the money handling machine 10 itself, and information about a sum of the money that has been processed by the money handling machine 10.

A collection notice indicating that money has been collected is transmitted from the money handling machine 10 to the armored car services management server 25, when a collection button (not shown) disposed on the money handling machine 10 is pushed down, or when a collection cassette (not shown), in which the money collected from the money handling machine 10 has been received, is drawn out.

In order that the collection button is pushed down so as to transmit a collection notice to the stocking machine 20, the money handling machine 10 may be configured to request an operator such as a collecting staff of the armored car company to input passwords, or may be configured to enable the pushing down of the collection button when an ID card is inserted.

As shown in FIG. 1, located in the center of the armored car company is a money processing unit 29, by which money is subjected to a sorting process by denomination, a sorting process by fitness, a bundling process, and so on.

Next, an operation of this embodiment as structured above is described.

In this embodiment, each time the money handling machine 10 processes money, the money handling machine 10 transmits to the armored car services management server 25 the information about the store in which the money handling machine 10 is located, the information about the money handling machine 10 itself, and the information about a sum of the money that has been processed by the money handling machine 10.

Thus, the armored car services management server 25 stores the latest information about the sum of the money that has been processed by the money handling machine 10, in relation to the information about the store in which the money handling machine 10 is located and the information about the money handling machine 10 itself.

The money handling machine 10 located in the store is owned by the armored car company. Thus, the money handling machine 10 is periodically maintained by the armored car company, and thus the reliability of the information about the sum of the money stored therein is high. Therefore, the information about the sum of the money stored in the money handling machine 10, which is stored in the security transport server 25, can be used as correct information.

When a collecting staff of the armored car company collects the money from the money handling machine 10 located in the store (or after the collecting staff has collected the money), a collection notice indicating that the money has been collected is informed to the armored car services management server 25 located on the armored car company. At this time, transmitted as the storage information to the armored car services management server 25 are the information about the store in which the money handling machine 10 is located (location information of the store, number of the store, etc.) and the information about the money handling machine 10 itself (number of the money handling machine, etc.). At this stage, when there is information about a sum of money which has been already processed by the money handling machine 10 but the information is not yet transmitted because of a time lag, the information about the sum of the money (the number of banknotes for each denomination, etc.) is also transmitted.

In this manner, when the money handling machine 10 transmits the collection notice to the armored car services management server 25 and the armored car services management server 25 receives the collection notice, the deposit accepting process is performed.

As described above, since the money handling machine 10 located in the store is owned by the armored car company, the information about the sum of the money, which has been obtained from the money handling machine 10 and is stored in the armored car services management server 25, can be used as correct information. Thus, when the stocking machine 20 receives the collection notice, the deposit accepting process can be performed just at this time. As a result, the deposit sum can be accepted at an early stage, and the money whose deposit sum has been accepted can be used in various applications at an early stage, whereby the amount of applicable money can be practically increased.

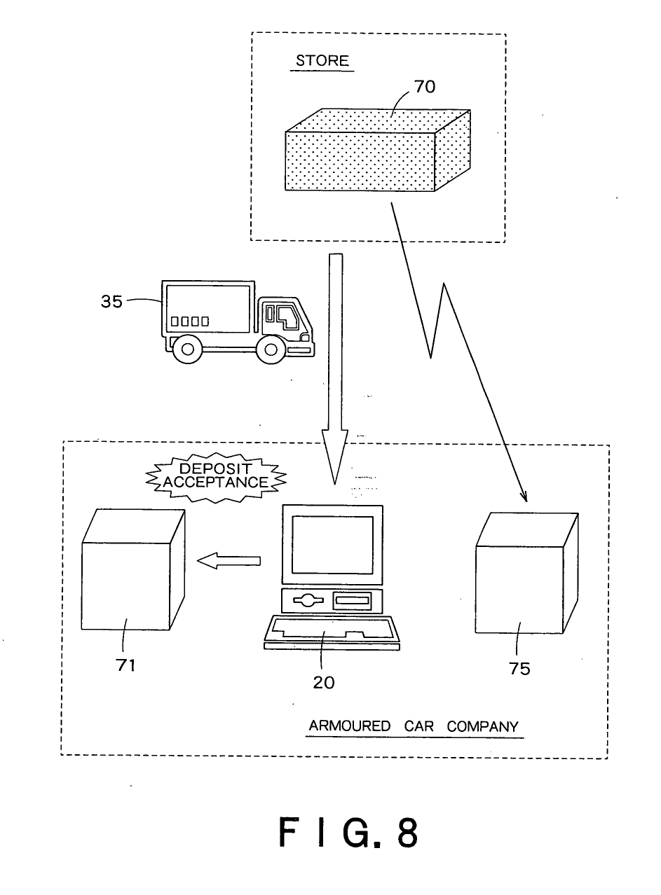

In addition, since the information about the sum of the money, which has been obtained from the money handling machine 10, can be used as correct information, it is not necessary to again count the money by the money handling machine 75 (see, FIG. 8) located in the armored car company, which has been necessary in the conventional technique. Further, when a count result of the deposit machine (money handling machine) 70 (see, FIG. 8) located in the store does not correspond to a count result of the money handling machine 75 owned by the armored car company, it is not necessary to amend the count result of the deposit machine (money handling machine) 70, which has been necessary in the conventional technique.

In addition, in this embodiment, each time the money handling machine 10 processes money, the money handling machine 10 transmits to the armored car services management server 25 the information about the store in which the money handling machine 10 is located, the information about the money handling machine 10 itself, and the information about the sum of the money that has been processed by the money handling machine 10. When the armored car services management server 25 receives a collection notice from the money handling machine 10, the deposit accepting process is performed. Thus, it is not necessary to use a header card or the like for distinguishably showing from which money handling machine 10 the money has been collected, which has been conventionally necessary. Therefore, efficiency and reliability of the process can be improved.

After the deposit accepting process has been performed as described above, the money collected from the store is taken to the armored car company by transport means 35 such as a car. Then, the money is sorted by denomination, sorted by fitness, and/or bundled, by the money processing unit 29 located in the center of the armored car company.

In the above embodiment, each time the money handling machine 10 processes money, the storage information is transmitted to the armored car services management server 25. However, not limited thereto, for example, the money handling machine 10 may sum up the processed money so as to create storage information, and transmit the created storage information to the armored car services management server 25 only when the money handling machine 10 transmits a collection notice.

### Second Embodiment

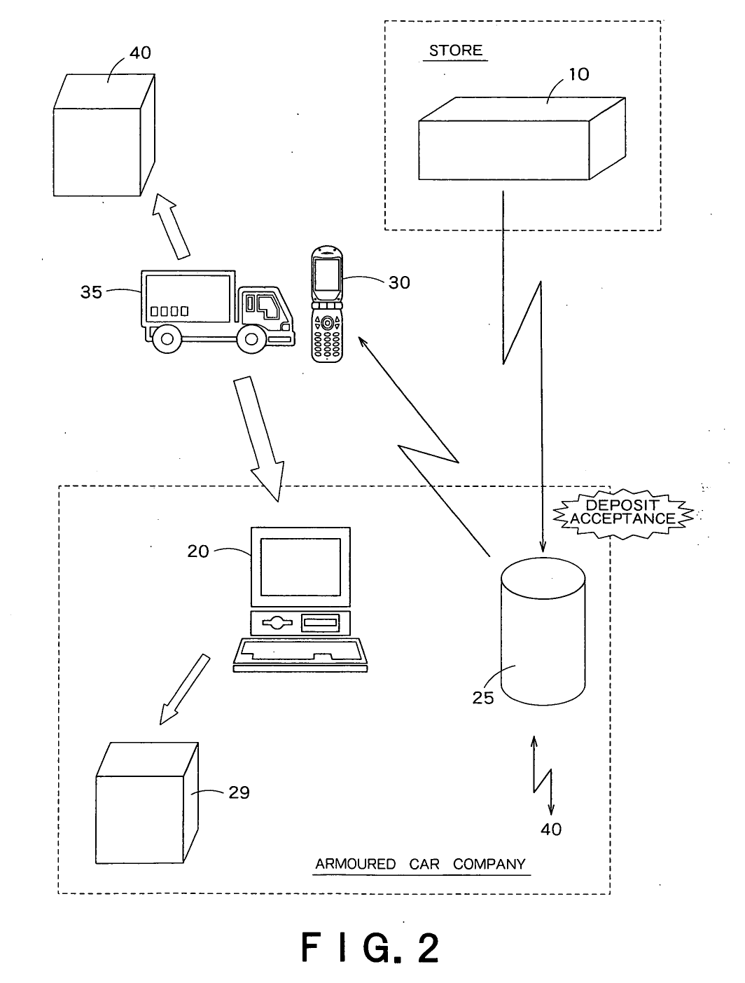

Next, a second embodiment of the present invention will be described with reference to FIG. 2. In the second embodiment shown in FIG. 2, a money management system further includes a portable terminal 30 formed of a portable mobile phone or the like. An armored car services management server 25 transmits to the mobile terminal 30 a sum of money to be taken to the armored car company, and a sum of money to be used for a replenishing process. At this time, the armored car services management server 25 obtains balance information about a balance (amount of money) in a money handling machine (ATM or the like) to be replenished with money, which is located in a financial institution, or a money handling machine (money register or the like) to be replenished with money, which is located in a store. Based on the balance information and the storage information, the armored car services management server 25 determines a sum of money to be taken to the armored car company and a sum of money to be used for a replenishing process. Other structures of the second embodiment are substantially the same as those of the first embodiment shown in FIG. 1.

In the second embodiment shown in FIG. 2, the same parts as the first embodiment shown in FIG. 1 are shown by the same reference numbers, and detailed description thereof is omitted.

In this embodiment, as shown in FIG. 2, the armored car services management server 25 is configured to transmit a sum of money to be taken to the armored car company and a sum of money to be used for a replenishing process to the portable terminal 30 carried by a collecting staff of the armored car company who collects money from a money handling machine 10 of a store.

The sum of money to be taken to the armored car company and the sum of money to be used for a replenishing process are determined by the armored car services management server 25, based on the balance information, which has been obtained from the money handling machine located in the financial institution or the money handling machine located in the store (hereinafter referred to as “money handling machine to be replenished with money 40” in this embodiment), and the storage information about the money having been subjected to the deposit accepting process, which has been obtained from the money handling machine 10 of the store.

Transmitted from each money handling machine to be replenished with money 40 to the armored car services management server 25 is position information of the corresponding money handling machine to be replenished with money 40. This position information is used when it is determined which money handling machine to be replenished with money 40 is replenished with money.

Namely, the armored car services management server 25 selects a suitable collecting staff based on the balance information and the position information of the respective money handling machines to be replenished with money 40, and transmits to the portable terminal 30 of the selected collecting staff the information about the target money handling machine to be replenished with money 40 and a sum of money to be replenished.

It is preferable that the portable terminal 30 has a GPS function, because position information based on the GPS function can be also considered when a suitable collecting staff is selected by the armored car services management server 25.

According to this embodiment, a sum of money to be taken to the armored car company and a sum of money to be used for a replenishing process are transmitted from the armored car services management server 25 to the portable terminal 30 carried by a collecting staff. Thus, the collecting staff can bring money, which has been collected from the money handling machine 10 of the store, directly to the money handling machine to be replenished with money 40 by the transport means 35, such as a car, and can replenish the money handling machine to be replenished with money 40 with the money, without bringing the money back to the armored car company.

Namely, also in this embodiment similarly to the first embodiment, when a collection notice is transmitted from the money handling machine 10 to the armored car services management server 25, the armored car services management server 25 performs the deposit accepting process.

Thus, the collecting staff can bring the money having been subjected to the deposit accepting process (at an early stage) directly to the money handling machine to be replenished with money 40 and can replenish the same with the money, without bringing the money back to the armored car company. As a result, in a vast country such as the USA, a cost for transporting money can be significantly reduced.

In addition, when a large amount of money is transported in the USA, the money is generally transported in arms for robbery. Since such arming needs a high cost, it is very beneficial that the money can be brought directly to the money handling machine to be replenished with money 40 so as to be replenished.

### Third Embodiment

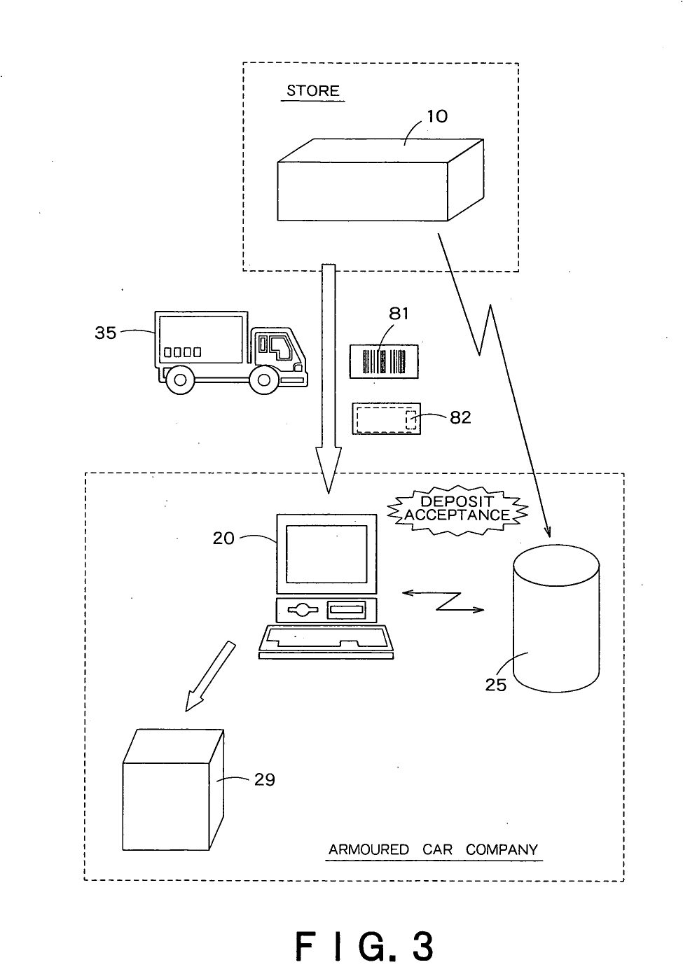

Next, a third embodiment of the present invention will be described with reference to FIG. 3. In the first embodiment shown in FIG. 1, when the armored car services management server 25 receives a collection notice indicating that the money has been collected from the money handling machine 10, the deposit accepting process is performed. On the other hand, in the third embodiment shown in FIG. 3, the deposit accepting process is performed when collection information used by a stocking machine 20 for a stocking confirmation (collection completed information) conforms to the storage information obtained from the money handling machine 10. Other structures of the third embodiment are substantially the same as those of the first embodiment shown in FIG. 1.

In the third embodiment shown in FIG. 3, the same parts as the first embodiment shown in FIG. 1 are shown by the same reference numbers, and detailed description thereof is omitted.

Also in this embodiment similarly to the first embodiment, each time the money handling machine 10 processes money, the money handling machine 10 transmits the storage information to the armored car services management server 25. Alternatively, the money handling machine 10 sums up the processed money so as to create storage information, and transmits the created storage information only when the money handling machine 10 transmits a collection notice.

When the armored car services management server 25 located in a center of an armored car company receives the collection notice, the armored car services management server 25 recognizes that money has been collected from the money handling machine 10 located in a store.

On the other hand, when the money is collected from the money handling machine 10 located in the store, the collection information about the money collected from the money handling machine 10 is printed as a character or a barcode on a paper medium 81 such as a receipt, or stored in a memory medium 82 such as an IC tag. The collection information includes, at least, information about the store in which the money handling machine 10 is located or information about the money handling machine 10 itself. In addition, the collection information may optionally include information about a sum of money stored in the money handling machine 10 (the number of banknotes for each denomination, etc.).

Thereafter, the collected money is taken to the center of the armored car company. Thereafter, the stocking machine 20 or the armored car services management server 25 checks up the storage information of the money handling machine 10 (in particular, the information about the store or the information about the money handling machine 10 itself), which has been recognized by the armored car services management server 25, with the collection information (in particular, the information about the store or the information about the money handling machine 10 itself), which has been printed on the paper medium 81 or stored in the memory medium 82, so as to know Whether the storage information and the collection information conform to each other.

When it is confirmed that the storage information stored in the armored car services management server 25 and the collection information printed on the paper medium 81 or stored in the memory medium 82 conform to each other, the deposit accepting process is performed by the stocking machine 20 or the armored car services management server 25.

As described above, also in this embodiment, since the money handling machine 10 located in the store is owned by the armored car company, the information about the sum of money, which has been obtained from the money handling apparatus 10 and stored in the armored car services management server 25, can be used as correct information. Thus, when it is confirmed that the collection information and the storage information conform to each other, the deposit accepting process can be performed just at this time. As a result, the deposit sum can be accepted at an early stage, and the money whose deposit sum has been accepted can be used in various applications at an early stage, whereby the amount of applicable money can be practically increased.

In addition, in this embodiment, the storage information of the money handling machine 10, which has been recognized by the armored car services management server 25, and the collection information are checked up with each other so as to know whether the storage information and the collection information conform to each other. Thus, whether or not the money collected from the money handling machine 10 is surely taken to the center of the armored car company can be confirmed.

### Fourth Embodiment

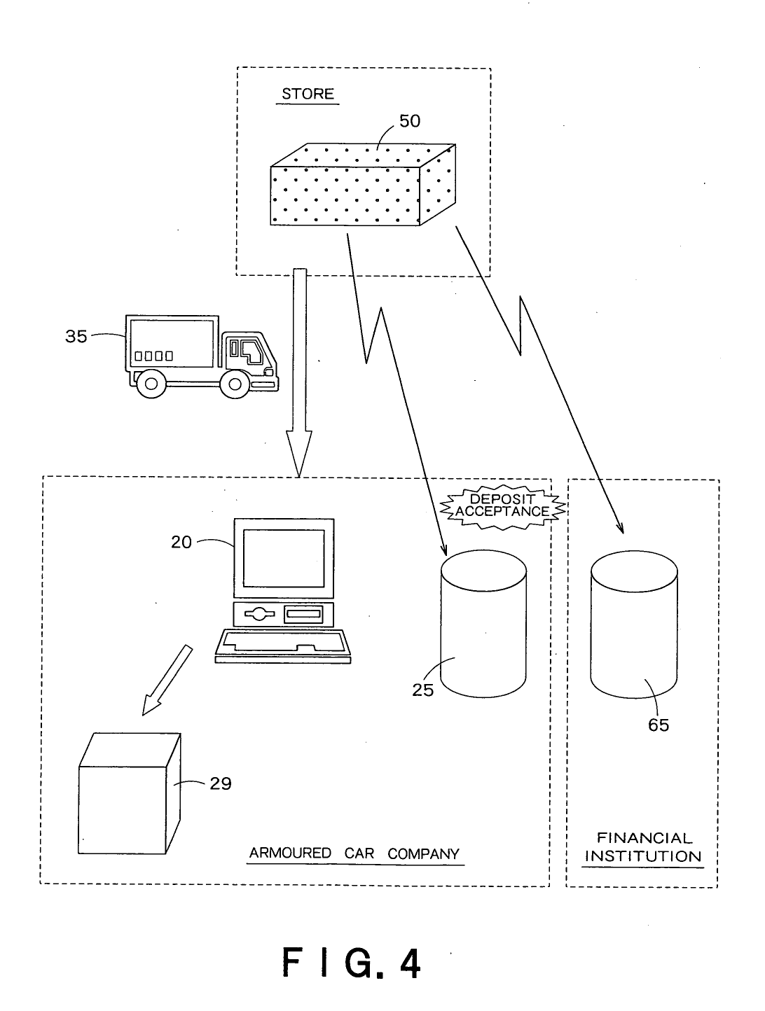

Next, a fourth embodiment of the present invention will be described with reference to FIG. 4. In the first embodiment shown in FIG. 1, the money handling machine 10 located in the store is owned by the armored car company. On the other hand, in the fourth embodiment shown in FIG. 4, a money handling machine 50 located in a store is owned by a financial institution such as a bank. In addition, located in the financial institution is a financial management server 65 that obtains storage information about money stored in the money handling machine 50, and stores the storage information. Other structures of the fourth embodiment are substantially the same as those of the first embodiment shown in FIG. 1.

In the fourth embodiment shown in FIG. 4, the same parts as the first embodiment shown in FIG. 1 are shown by the same reference numbers, and detailed description thereof is omitted.

As described below, the same effect as that of the first embodiment can be provided by this embodiment.

Namely, in this embodiment, the money handling machine 50 located in the store is owned by the financial institution. Thus, the money handling machine 50 is periodically maintained (similarly to the case in which the money handling machine is owned by an armored car company), whereby the reliability of information about a sum of the processed money is high. Therefore, the information about a sum of the money processed by the money handling machine 50, which is stored in the armored car services management server 25, can be used as correct information.

Thus, when the armored car services management server 25 located in the armored car company receives a collection notice from the money handling machine 50, the deposit accepting process can be performed just at this time. As a result, the deposit sum can be accepted at an early stage, and the money whose deposit sum has been accepted can be used in various applications at an early stage, whereby the amount of applicable money can be practically increased.

In addition, the information about the sum of the money obtained from the money handling machine 50 can be used as correct information. Thus, similarly to the first embodiment, it is not necessary to again count the money by the money handling machine 75 (see, FIG. 8) located in the armored car company, which has been necessary in the conventional technique. Further, when a count result of the deposit machine (money handling machine) 70 (see, FIG. 8) located in the store does not correspond to a count result of the money handling machine 75 owned by the armored car company, it is not necessary to amend the count result of the deposit machine (money handling machine) 70, which has been necessary in the conventional technique.

In this embodiment, the same information as the information that is transmitted from the money handling machine 50 to the armored car services management server 25 is transmitted to the financial management server 65 located in the financial institution.

Namely, each time the money handling machine 50 processes money, the money handling machine 50 transmits the storage information to the financial management server 65 located in the financial institution. Alternatively, the money handling machine 50 sums up the processed money so as to create storage information, and transmits the created storage information only when the money handling machine 50 transmits a collection notice.

When a collecting staff of the armored car company collects money from the money handling machine 50 located in the store (or after the collecting staff has collected the money), a collection notice indicating that the money has been collected is informed to the financial management server 65.

### Fifth Embodiment

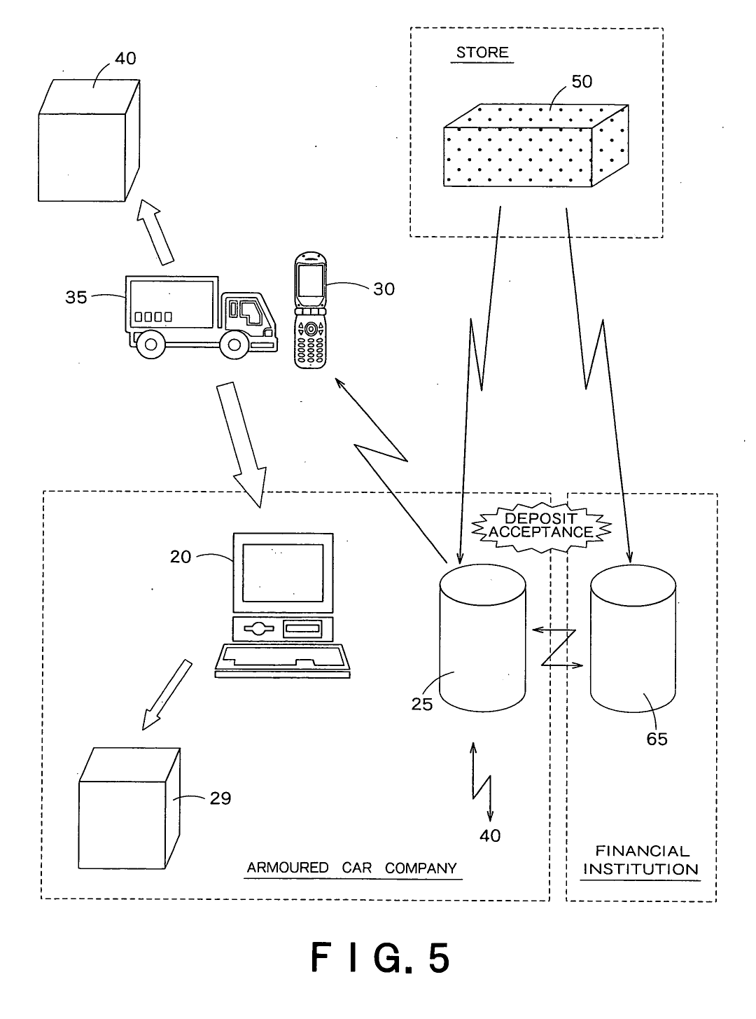

Next, a fifth embodiment of the present invention will be described with reference to FIG. 5. In the fifth embodiment shown in FIG. 5, a portable terminal 30 formed of a portable mobile phone or the like is further provided. An armored car services management server 25 is configured to transmit to the portable terminal 30 information about a sum of money to be taken to an armored car company and information about a sum of money to be used for a replenishing process. At this time, the armored car services management server 25 obtains balance information about a balance (amount of money) in a money handling machine (ATM or the like) to be replenished with money, which is located in a financial institution, or a money handling machine (money register or the like) to be replenished with money, which is located in a store. Based on the balance information and the storage information, the armored car services management server 25 determines a sum of money to be taken to the armored car company and a sum of money to be used for a replenishing process. Other structures of the fifth embodiment are substantially the same as those of the fourth embodiment shown in FIG. 4.

In the fifth embodiment shown in FIG. 5, the same parts as the fourth embodiment shown in FIG. 4 are shown by the same reference numbers, and detailed description thereof is omitted.

As described below, the same effect as that of the second embodiment can be provided by this embodiment.

Namely, in this embodiment, as shown in FIG. 5, the armored car services management server 25 is configured to transmit a sum of money to be taken to an armored car company and a sum of money to be used for a replenishing process, to the portable terminal 30 carried by a collecting staff of the armored car company who collects money from a money handling machine 50 of a store.

Thus, the collecting staff can bring money, which has been collected from the money handling machine 50 of the store, directly to a money handling machine to be replenished with money 40 by transport means 35, such as a car, and can replenish the money handling machine 40 with the money, without bringing the money back to the armored car company.

Namely, also in this embodiment similarly to the fourth embodiment, when a collection notice is transmitted from the money handling machine 50 to the armored car services management server 25, the armored car services management server 25 performs the deposit accepting process.

Thus, the collecting staff can bring the money having been subjected to the deposit accepting process (at an early stage) directly to the money handling machine to be replenished with money 40 and can replenish the same with the money, without bringing the money back to the armored car company. As a result, in a vast country such as the USA (in particular, in a country where it is necessary to transport money in arms), a cost for transporting money can be significantly reduced.

Also in this embodiment similarly to the second embodiment, transmitted from each money handling machine to be replenished with money 40 to the armored car services management server 25 is position information of the corresponding money handling machine to be replenished with money 40. This position information is used when the armored car services management server 25 determines which money handling machine 40 is replenished with money.

It is preferable that the portable terminal 30 has a GPS function, because position information based on the GPS function can be also considered when a suitable collecting staff is selected by the armored car services management server 25.

In this embodiment, the money handling machine 50 located in the store is owned by the financial institution. Thus, a sum of money to be taken to the armored car company virtually corresponds to a sum of money borrowed from the financial institution or a sum of money purchased therefrom. Therefore, the armored car services management server transmits to the financial management server 65 information about the sum of money to be taken and information about the sum of money to be used for a replenishing process. In accordance with the information transmitted from the armored car services management server 25, the financial management server 65 updates the information held by the same.

### Sixth Embodiment

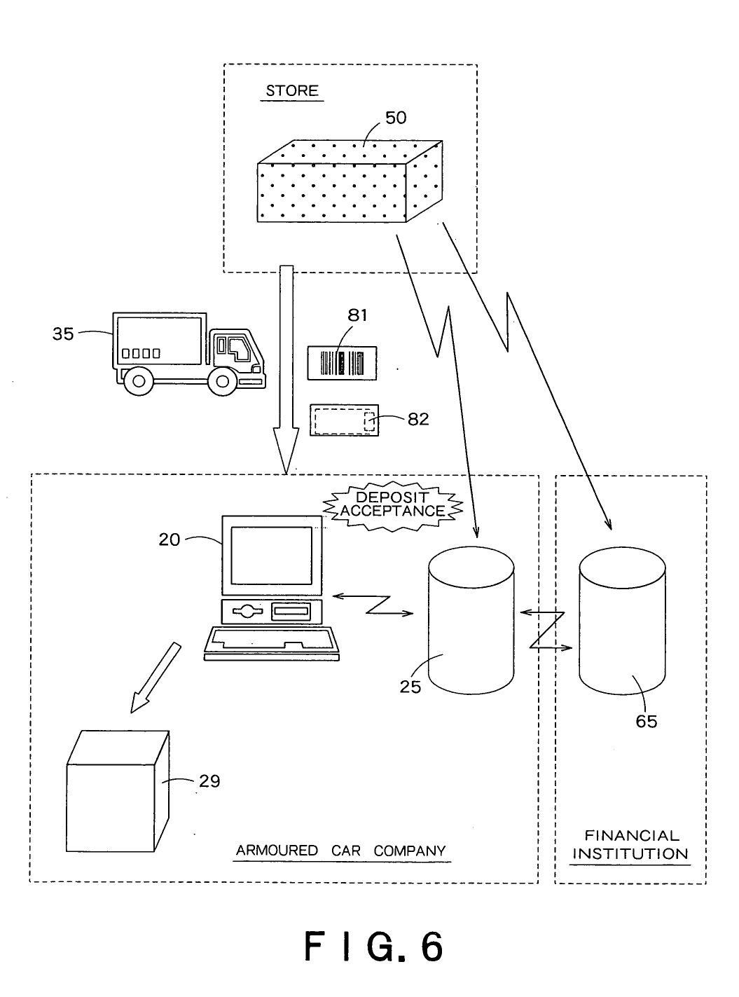

Next, a sixth embodiment of the present invention will be described with reference to FIG. 6. In the fourth embodiment shown in FIG. 4, when the armored car services management server 25 receives a collection notice indicating that money has been collected from the money handling machine 50, the deposit accepting process is performed. On the other hand, in the sixth embodiment shown in FIG. 6, the deposit accepting process is performed when collection information used by a stocking machine 20 for a stocking confirmation conforms to storage information obtained from the money handling machine 50. Other structures of the sixth embodiment are substantially the same as those of the fourth embodiment shown in FIG. 4.

In the sixth embodiment shown in FIG. 6, the same parts as the fourth embodiment shown in FIG. 4 are shown by the same reference numbers, and detailed description thereof is omitted.

As described below, the same effect as that of the third embodiment can be provided by this embodiment.

Namely, also in this embodiment similarly to the fourth embodiment, a money handling machine 50 owned by a financial institution transmits the storage information to the armored car services management server 25.

When the armored car services management server 25 located in a center of an armored car company receives the collection notice, the armored car services management server 25 recognizes that money has been collected from the money handling machine 50 located in a store.

On the other hand, when the money is collected from the money handling machine 50 located in the store, the collection information about the money collected from the money handling machine 50 is printed on a paper medium 81, or stored in a memory medium 82. The collection information includes, at least, information about the store in which the money handling machine 50 is located or information about the money handling machine 50 itself.

Thereafter, the collected money is taken to the center of the armored car company. Then, the stocking machine 20 or the armored car services management server 25 checks up the storage information of the money handling machine 50, which has been recognized by the armored car services management server 25, with the collection information, which has been printed on the paper medium 81 or stored in the memory medium 82, so as to know whether the storage information and the collection information conform to each other.

When it is confirmed that the storage information stored in the armored car services management server 25 and the collection information printed on the paper medium 81 or stored in the memory medium 82 conform to each other, the deposit accepting process is performed by the stocking machine 20 or the armored car services management server 25.

As described above, also in this embodiment, since the money handling machine 50 located in the store is owned by the financial institution, the information about the sum of the money which has been obtained from the money handling apparatus 50 and stored in the armored car services management server 25 can be used as correct information. Thus, when it is confirmed that the collection information and the storage information conform to each other, the deposit accepting process can be performed just at this time. As a result, the deposit sum can be accepted at an early stage, and the money whose deposit sum has been accepted can be used in various applications at an early stage, whereby the amount of applicable money can be practically increased.

In addition, in this embodiment, the storage information of the money handling machine 50, which has been recognized by the armored car services management server 25, and the collection information are checked up with each other so as to know whether the storage information and the collection information conform to each other. Thus, whether or not the money collected from the money handling machine 50 is surely taken to the center of the armored car company can be confirmed.

In this embodiment, when it is confirmed that the storage information, which has been stored in the armored car services management server 25, and the collection information, which has been printed on the paper medium 81 or stored in the memory medium 82, conform to each other, the financial management server 65 is informed by the armored car services management server 25 of the fact that the collection information and the storage information conform to each other. Based on this notice, the financial management server 65 can confirm whether the money collected from the money handling machine 50 is surely taken to a center of the armored car company.

### Seventh Embodiment

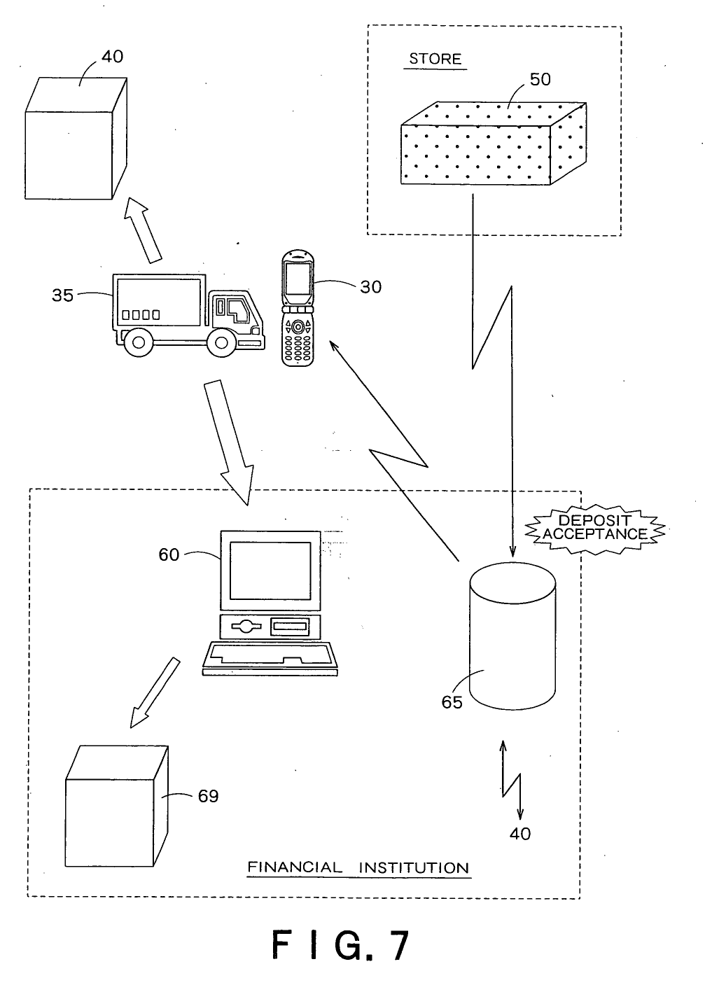

Next, a seventh embodiment of the present invention will be described with reference to FIG. 7. In the second embodiment shown in FIG. 2, the money handling machine 50 located in the store is owned by the armored car company. On the other hand, in the seventh embodiment shown in FIG. 7, a money handling machine 50 located in a store is owned by a financial institution. In addition, in the second embodiment shown in FIG. 2, the stocking machine 20 located in the armored car company is informed of the fact that money has been collected. On the other hand, in the seventh embodiment shown in FIG. 7, a stocking machine 60 located in the financial institution is informed of the fact that money has been collected. In addition, in the second embodiment shown in FIG. 2, the money having been subjected to the deposit accepting process is sorted by denomination, sorted by fitness, and/or bundled, by the money processing unit 29 located in the armored car company. On the other hand, in the seventh embodiment shown in FIG. 7, the money having been subjected to the deposit accepting process is sorted by denomination, sorted by fitness, and/or bundled, by a money processing unit 69 located in a main center of the financial institution. Further, in the seventh embodiment shown in FIG. 7, a financial management server 65 carries out the function of the armored car services management server 25 in the seventh embodiment shown in FIG. 2. Other structures of the seventh embodiment are substantially the same as those of the second embodiment shown in FIG. 2.

In the seventh embodiment shown in FIG. 7, the same parts as the second embodiment shown in FIG. 2 are shown by the same reference numbers, and detailed description thereof is omitted.

As described below, the same effect as that of the second embodiment can be provided by this embodiment.

Namely, in this embodiment, as shown in FIG. 7, the financial management server 65 transmits to a mobile terminal 30 carried by a collecting staff of the armored car company who collects money from the money handling machine 50 of the store, a sum of money to be taken to the main center such as a central office of the financial institution, and a sum of money to be used for a replenishing process for a money handling machine (ATM or the like) located in the financial institution and/or a money handling machine (money register or the like) located in the store (hereinafter referred to as “money handling machine to be replenished with money 40” in this embodiment).

Thus, the collecting staff can bring money, which has been collected from the money handling machine 50 of the store, directly to the money handling machine to be replenished with money 40 by transport means 35, such as a car, and can replenish the money handling machine to be replenished with money 40 with the money, without bringing the money back to the main center of the financial institution.

Namely, also in this embodiment similarly to the second embodiment, when a collection notice is transmitted from the money handling machine 50 to the financial management server 65, the financial management server 65 performs the deposit accepting process. (In the second embodiment, a collection notice is transmitted from the money handling machine 10 to the armored car services management server 25.)

Thus, the collecting staff can bring the money having been subjected to the deposit accepting process (at an early stage) directly to the money handling machine to be replenished with money 40 and can replenish the same with the money, without bringing the money back to the armored car company. As a result, in a vast country such as the USA (in particular, in a country where it is necessary to transport money in arms), a cost for transporting money can be significantly reduced.

Also in this embodiment similarly to the second embodiment, transmitted from each money handling machine to be replenished with money 40 to the financial management server 65 is position information of the corresponding money handling machine to be replenished with money 40. This position information is used when the financial management server 65 determines which money handling machine 40 is replenished with money.

It is preferable that the portable terminal 30 has a GPS function, because position information based on the GPS function can be also considered when a suitable collecting staff is selected by the financial management server 65.

1. A money management system comprising:
a money handling machine located in a store and owned by an armored car company; and
an armored car services management server located in the armored car company, the armored car services management server being configured to obtain storage information about money stored in the money handling machine and to store the storage information therein;
wherein a deposit accepting process is performed based on collection completed information indicating that money has been collected from the money handling machine.

2. The money management system according to claim 1, wherein
the collection completed information includes a collection notice that is sent from the money handling machine to the armored car services management server to inform that the money has been collected from the money handling machine, and
the deposit accepting process is performed when the armored car services management server receives the collection notice.

3. The money management system according to claim 1, further comprising a money receiving unit located in the armored car company, the money receiving unit being configured to confirm delivery of money by using collection information about money that has been collected from the money handling machine,
wherein the collection completed information includes the collection information, and
the deposit accepting process is performed when it has been confirmed that the collection information and the storage information conform to each other.

4. The money management system according to claim 1, wherein
the money handling machine is configured to transmit the storage information to the armored car services management server each time the money handling machine processes money.

5. The money management system according to claim 1, wherein
the money handling machine is configured to sum up processed money so as to create the storage information, and to transmit the storage information to the armored car services management server.

6. The money management system according to claim 1, wherein
the money handling machine is configured to transmit, as the storage information, information about the store in which the money handling machine is located or information about the money handling machine itself, and information about money stored in the money handling machine, to the armored car services management server.

7. The money management system according to claim 3, wherein
when money is collected from the money handling machine, the money handling machine is configured to print on a paper medium the collection information about the money collected from the money handling machine, or to store in a memory medium the collection information about the money collected from the money handling machine.

8. The money management system according to claim 2, further comprising a portable terminal,
wherein the armored car services management server is configured to transmit to the portable terminal a sum of money to be taken to the armored car company and a sum of money to be used for a replenishing process.

9. The money management system according to claim 8, wherein
the armored car services management server is configured to obtain balance information about a balance (amount of money) in a money handling machine to be replenished, and to determine the sum of money to be taken to the armored car company and the sum of money to be used for a replenishing process, based on the balance information and the storage information.

10. A money management system comprising:
a money handling machine located in a store and owned by a financial institution; and
an armored car services management server located in an armored car company, the armored car services management server being configured to obtain storage information about money stored in the money handling machine and to store the storage information therein;
wherein a money acceptance process is performed based on collection completed information indicating that money has been collected from the money handling machine.

11. The money management system according to claim 10, wherein
the collection completed information includes a collection notice that is sent from the money handling machine to the armored car services management server to inform that the money has been collected from the money handling machine, and
the deposit accepting process is performed when the armored car services management server receives the collection notice.

12. The money management system according to claim 10, further comprising a money receiving unit located in the armored car company, the money receiving unit being configured to confirm delivery of money by using collection information about money that has been collected from the money handling machine,
wherein the collection completed information includes the collection information, and
the money acceptance process is performed when it has been confirmed that the collection information and the storage information conform to each other.

13. The money management system according to claim 10, further comprising a financial management server located in the financial institution, the financial management server being configured to obtain the storage information about money stored in the money handling machine, and to store the storage information therein.

14. The money management system according to claim 10, wherein
the money handling machine is configured to transmit the storage information to the armored car services management server each time the money handling machine processes money.

15. The money management system according to claim 10, wherein
the money handling machine is configured to sum up processed money so as to create the storage information, and to transmit the storage information to the armored car services management server.

16. The money management system according to claim 10, wherein
the money handling machine is configured to transmit, as the storage information, information about the store in which the money handling machine is located or information about the money handling machine itself, and information about money stored in the money handling machine, to the armored car services management server.

17. The money handling system according to claim 12, wherein
when money is collected from the money handling machine, the money handling machine is configured to print on a paper medium the collection information about the money collected from the money handling machine, or to store in a memory medium the collection information about the money collected from the money handling machine.

18. The money management system according to claim 11, further comprising a portable terminal,
wherein the armored car services management server is configured to transmit to the portable terminal a sum of money to be taken to the armored car company and a sum of money to be used for a replenishing process.

19. The money management system according to claim 18, wherein
the armored car services management server is configured to obtain balance information about a balance (amount of money) in a money handling machine to be replenished, and to determine the sum of money to be taken to the armored car company and the sum of money to be used for a replenishing process, based on the balance information and the storage information.

20. A money management system comprising:
a money handling machine located in a store and owned by a financial institution; and
an armored car services management server located in the financial institution, the armored car services management server being configured to obtain storage information about money stored in the money handling machine and to store the storage information therein;
wherein a deposit accepting process is performed based on collection completed information indicating that money has been collected from the money handling machine.
